(19) United States
(12) Patent Application Publication
(10) Pub. No.: US 2023/0071659 A1
(43) Pub. Date: Mar. 9, 2023

(54) AUTOFEED PAPER SHREDDER WITH INPUT DRAWER

(71) Applicant: Herman CHANG, Rancho Dominguez, CA (US)

(72) Inventor: Herman CHANG, Rancho Dominguez, CA (US)

(21) Appl. No.: 17/977,332

(22) Filed: Oct. 31, 2022

Related U.S. Application Data
(63) Continuation-in-part of application No. 16/786,887, filed on Feb. 10, 2020, now Pat. No. 11,511,285.
Application No. 16/786,887 is a continuation of application No. 14/468,235, filed on Aug. 25, 2014, now Pat. No. 10,556,236.
(60) Provisional application No. 61/869,520, filed on Aug. 23, 2013.

(51) Int. Cl. B02C 18/00; B02C 18/22

(52) U.S. Cl. CPC B02C 18/0007; B02C 18/2225; B02C 18/2283; B02C 2018/2208

(57) ABSTRACT

An auto-feed paper shredder is configured for placement below the surface of a desk. The auto-feeder consists of a drawer located on the front surface of the shredder. This drawer is slid out to insert a stack of documents to be shredded. When the door is slid back into the shredder and the shredding system is activated, feed rollers draw sheets of paper either from the top or the bottom surface of the stack and feed the sheets into a conventional paper shredding mechanism. An input slot is provided to insert single sheets of paper when the auto-feeder is not being used.

### CROSS-REFERENCE TO PRIOR APPLICATIONS

This application is a continuation-in-part of U.S. Utility patent application Ser. No. 16/786,887, filed Feb. 10, 2020, which claimed the benefit of being a continuation of U.S. Utility patent application Ser. No. 14/468,235 filed Aug. 25, 2014, which issued as U.S. Pat. No. 10,553,236 on Feb. 11, 2020, which claimed the benefit of U.S. Provisional Patent Application No. 61/869,520, filed on Aug. 23, 2013, all of which are incorporated herein by reference.

### U.S. Government Support

Not Applicable.

### BACKGROUND OF THE INVENTION

### Area of the Art

This invention relates to a paper shredder with built-in auto-feed capability that is configured for location beneath a desk.

### DESCRIPTION OF THE BACKGROUND

Modern paper shredders for shredding documents incorporate counter rotating shafts bearing blades and spacers so that paper passing between the blades is effectively shredded. The maximum sheet capacity of such paper shredders is dependent on the strength of the motor and the limitations of the cutting blades and rotary shafts. Although many units can handle small stacks of 10-20 sheets, when a large amount of paper must be destroyed, the user needs to stand by the unit and continuously feed the machine stacks of paper that are within the maximum sheet capacity of the unit. If even a relatively small number of sheets are to be shredded, it is usually necessary for the user to get up and walk to the shredder because most units must be fed from the top making it difficult or impossible to locate the machine conveniently beneath a desk. For single sheet paper shredders, it is known to place the input slot on the side of the shredder near the top or on a bevel of the upper corner of the shredder so that the unit can be conveniently placed beneath a desk with the input slot just below the underside of the desktop. That is, the input slot is located so as to be accessible when the unit is placed under a desk.

The problem of conveniently shredding large stacks can be solved by paper shredders equipped with an auto-feed mechanism that allows automatic feeding of the paper shredder from large stacks of documents. U.S. Pat. No. 5,362,002, the contents of which are incorporated herein by reference, discloses a paper shredder with automatic paper feeding device The feeding device includes an angled tray which is mounted to the device top adjacent the shredding roller assembly, a rotary shaft which is mounted rotatably on the tray, a tension spring which is connected to the rotary shaft and the tray, and at least one push rod, each rod having two pivotally connected rod sections. The device operates by feeding one or a few sheets of paper from the top of the paper stack in the tray into the throat of the shredder. A similar arrangement is found in U.S. Pat. No. 5,884,855, also incorporated herein by reference, which discloses a paper feed structure for paper shredders having a paper containing tray and paper feed adjustment device. Both of these auto-feeding devices simulate the manual feeding of paper into a shredder and both of them depend on an external tray which increases the overall height and profile of the unit.

What is really needed is a shredder with an integral auto-feed system. A good example is disclosed in U.S. Pat. No. 8,074,912, the content of which is incorporated herein by reference, wherein the paper shredder includes a driving roller assembly at the bottom of a paper compartment and a hinged top for closing the paper compartment and providing downward pressure on the stack of paper located within the compartment. The pivotal driving roller assembly includes a spaced apart pair of counter-rotating feeding rollers which extend through an opening in the bottom of the paper compartment to contact and grab a sheet of paper from the bottom of a stack of paper that has been placed in the compartment. The sheet is grabbed near its center and pulled between the rollers and then pushed into the shredding mechanism. When the compartment is empty, one or more sheets of paper can be pushed through a slot in the hinged top directly between the feeding rollers and into the shredding mechanism. Thus, this unit can function either as an auto-feed unit which shreds a large stack of sheets placed in the compartment or, when the compartment is empty, as a conventional paper shredder by inserting sheets directly into the shredding mechanism.

Although the shredder described in U.S. Pat. No. 8,074,912 is versatile, it cannot be placed below a desk because one needs to swing open the paper compartment doors to insert a stack of paper to be shredded and this would cause the doors to strike the underside of the desk.

### SUMMARY OF THE INVENTION

An auto-feed paper shredder is configured to be placed below a desk surface. The device has an input slot on the front surface, on a top bevel at or near the front of the top so that when the unit is slid beneath a desk surface, the input slot is still accessible. In addition, the unit has an input drawer for inputting an entire stack of papers to be processed by an auto-feed system. The drawer can be slid out from the unit and a stack of paper documents loaded therein. When the drawer is slid back into the unit shredding commences.

In one embodiment, the bottom interior surface of the tray is equipped with a biasing plate that becomes depressed when a stack of paper is inserted into the drawer. When the drawer is inserted into the shredder, the biasing plate exerts an upward force on the paper stack thereby bring the paper into contact with a feed roller or belt that draws single sheets of paper, one at a time, off the top of the stack and feeds them into the throat of the shredding mechanism. During the paper feed cycle, the belt or roller temporarily moves into position to contact the upper surface of the paper stack.

In an alternate embodiment the drawer has a slot in its bottom though which the counter-rotating feed rollers pass to contact the bottom sheet of the stack so as to pull paper sheets from the bottom of the stack and feed them into the shredder mechanism. The slot runs the width or length of the sheet and is located near the mid-point of the length or width. The counter-rotating rollers grab the bottom sheet and cause it to fold and be drawn between the rollers. Alternatively, the slot can be located near one of the edges of the sheet. With this configuration, a single sheet is pulled off the bottom of the stack either lengthwise or widthwise and directed into the shredding mechanism without the sheet being folded. The shredder is constructed so that when the feed rollers are in an active contacting position, the drawer is locked in a closed position. When the feed rollers are inactive, they retract and the drawer unlocks so that it can be refilled. When the user desires to withdraw the drawer to insert additional paper, the user presses a switch or a lever that unlocks the catch and simultaneously causes the feed rollers to retract allowing the drawer to be withdrawn.

For optimal operation, the drawer should be equipped with means to uniformly press the stack down onto the feed roller(s). This can be accomplished either by a spring-loaded,_hinged bias plate under which the sheets of paper are placed when one loads the drawer or by a mechanically driven pressure plate that descends into the drawer when it is inserted into the shredder.

This brief summary has been provided so that the nature of the invention may be understood quickly. Additional aspects and advantages of the present invention will be given in part in the following more detailed description, taken in conjunction with the accompanying drawings, which can become apparent from the following description, which illustrate, by way of example, the principles of the invention or be understood through practice of the present invention. Any drawings contained herein constitute a part of this specification and include exemplary embodiments of the present invention and illustrate various objects and features thereof.

### BRIEF DESCRIPTION OF THE FIGURES

The various present embodiments now will be discussed in detail with an emphasis on highlighting the advantageous features with reference to the drawings of various embodiments. The illustrated embodiments are intended to illustrate, but not to limit the invention. These drawings include the following figures, in which like numerals indicate like parts: The above and/or additional aspects and advantages of the present invention will be apparent and easily understood from the descriptions of the embodiments with reference to the following drawings, wherein:

FIG. 1 shows a drawing of a prior art shredder configured for placement below the surface of a desk;

FIG. 2 shows a drawing of the current invention, an auto-feed shredder configured for placement below a desk surface;

FIG. 3 shows a cross-sectional view of the shredder of FIG. 2 illustrating a top-feeding embodiment with at least one roller in an upper position, and a drawer in an open position;

FIG. 4 shows a cross-sectional view of the shredder of FIG. 2 illustrating the top-feeding embodiment of FIG. 3 with the drawer in a closed position, and at least one roller in a lower position contacting an upper surface of a stack of paper;

FIG. 5 shows a cross-sectional view of the shredder of FIG. 2 illustrating a bottom-feeding embodiment with at least one roller in a lower position, a pressure plate in a upper position, and a drawer in an open position;

FIG. 6 shows a cross-sectional view of the shredder of FIG. 2 illustrating the bottom-feeding embodiment of FIG. 5 with the drawer in a closed position, at least one roller in an upper position extending into a slot in a bottom of the drawer and contacting a lower surface of a stack of paper, and the pressure plate in a lower position and contacting an upper surface of the stack of paper;

FIG. 7 shows a cross-sectional view of the shredder of FIG. 2 illustrating another bottom-feeding embodiment with at least one roller in a lower position, a pressure plate in a upper position, and a drawer in an open position;

FIG. 8 shows a cross-sectional view of the shredder of FIG. 2 illustrating the bottom-feeding embodiment of FIG. 7 with the drawer in a closed position, at least one roller in an upper position extending into a slot in a bottom of the drawer and contacting a lower surface of a stack of paper, and the pressure plate in a lower position and contacting an upper surface of the stack of paper;

FIG. 9 shows a cross-sectional view of the shredder of FIG. 2 illustrating an additional bottom-feeding embodiment with at least one roller in a lower position, a pressure plate in a upper position, and a drawer in an open position;

FIG. 10 shows a cross-sectional view of the shredder of FIG. 2 illustrating the bottom-feeding embodiment of FIG. 9 with the drawer in a closed position, at least one roller in an upper position extending into a slot in a bottom of the drawer and contacting a lower surface of a stack of paper, and a pressure plate in a lower position and contacting an upper surface of the stack of paper;

FIG. 11 shows a cross-sectional view of the shredder of FIG. 2 illustrating still another bottom-feeding embodiment with at least one roller in a lower position, a pressure plate in a upper position, and a drawer in an open position; and

FIG. 12 shows a cross-sectional view of the shredder of FIG. 2 illustrating the bottom-feeding embodiment of FIG. 11 with the drawer in a closed position, at least one roller in an upper position extending into a slot in a bottom of the drawer and contacting a lower surface of a stack of paper, and the pressure plate in a lower position and contacting an upper surface of the stack of paper.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a paper shredder for placement below a desk surface and including a mechanism to shred sheets of paper pulled from a stack of sheets placed within a drawer integral to the shredder. The following detailed description describes the present embodiments, with reference to the accompanying drawings. In the drawings, reference numbers label elements of the present embodiments. These reference numbers are reproduced below in connection with the discussion of the corresponding drawing features, wherein identical or similar reference numerals denote identical or similar elements or elements having the same or similar functions. It is to be understood that the figures and descriptions of the present invention have been simplified to illustrate elements that are relevant for a clear understanding of the present invention, while eliminating, for the purpose of clarity, many other elements found in shredder devices. Those of ordinary skill in the pertinent arts may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the pertinent arts. The embodiments described hereinafter with reference to the drawings are exemplary and only intended to explain the present invention, and cannot be understood as limiting the present invention.

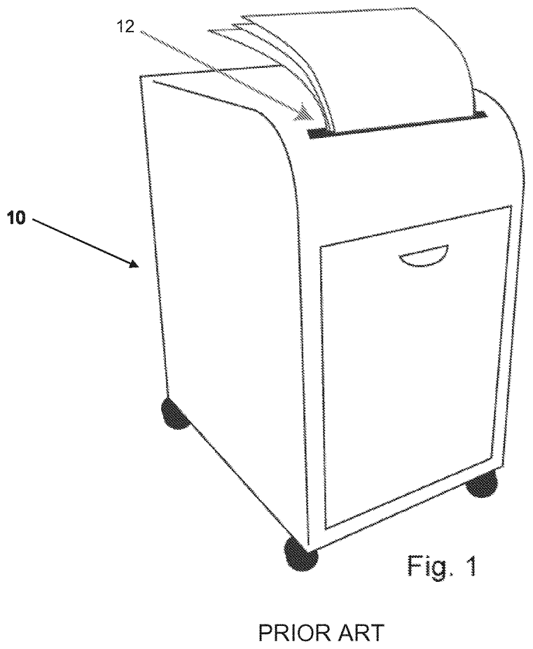

FIG. 1 shows a prior art paper shredder configured for placement below a desk surface. The shredder 10 includes an input slot 12 that is located on either a front surface or a beveled surface which joins the front surface of the unit to the top surface. Traditionally, the input slot 12 would be located on an upper surface of the shredder body, but when a shredder is located below a desk surface, a slot on the upper surface of the shredder is no longer accessible.

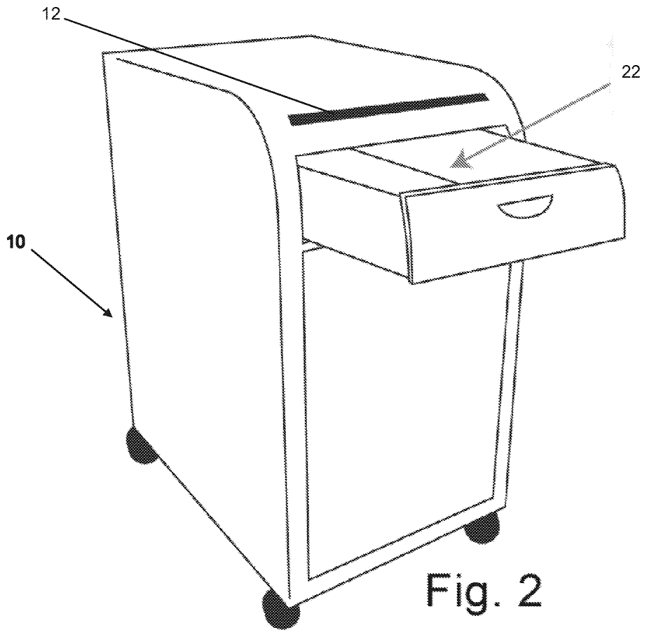

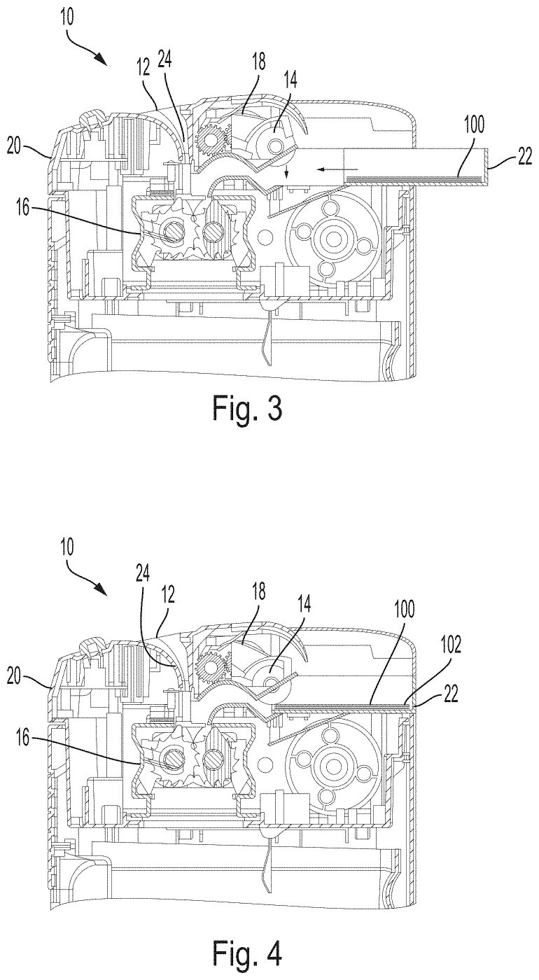

The present invention enables an auto-feed shredder as has been described above to be conveniently be place below a desk surface. As shown in FIGS. 2-4, the device has an input slot 12 on the front surface, on a top bevel or near the front of the top so that when the unit is slid beneath a desk surface, the input slot 12 is still accessible. Internally, the unit is much like a traditional shredder having a shredding mechanism 16 of spaced apart cutter blades disposed on two counter-rotating shafts disposed within a housing 20. A “throat” or chute 24 conducts the paper sheets into the shredding mechanism 16 where they are shredded by the counter-rotating blades. In addition to the typical input slot 12, the unit 10 has an autofeed input tray or input drawer 22 for inputting an entire stack of papers 100 to be processed by an auto-feed system 18. To use the tray or drawer 22, the tray or drawer 22 is slid out from the unit 10 and the stack of paper documents 100 is loaded into the tray or drawer 22. Then, the tray or drawer 22 is slid back into the unit 10, and the shredding commences. It will be appreciated that the input slot 12 can be above or below (or even feed directly into) the input drawer 22. The unit 10 has an access door 80 that opens and closes, and provides a user with access to an interior compartment of the unit 10 within which a waste bin 90 is disposed under the shredding mechanism 16 for collecting shredded paper that has passed through the blades of the shredding mechanism 16.

The drawer auto-feed 18 can operate in several different ways. In one top-feeding embodiment, the bottom interior surface of the tray or drawer 22 is equipped with a biasing plate that becomes depressed when a stack of paper 100 is inserted into the drawer 22. Similar to the structure of paper trays in copiers and printers, when a stack of paper 100 is loaded into the tray or drawer 22, the spring-loaded biasing plate becomes depressed by the weight of the paper stack 100. When the user presses down to insert the stack 100, the biasing plate locks into place so that it no longer exerts upward force on the stack 100. When the tray or drawer 22 is inserted into the shredder 10, the lock on the biasing plate is automatically released so that the biasing plate again exerts an upward force on the paper stack 100 thereby bringing the paper into contact with a feed roller or belt 14 that draws single sheets of paper, one at a time, off the top of the stack 100 and feeds them into the throat 24 of the shredding mechanism 16. Sheets of paper inserted through the input slot 12 move directly into the throat 24 of the shredder 10 generally without assistance of the feed rollers 14. For that reason it is usually preferred to place the input slot 12 above the tray or drawer 22 so that inserted sheets can feed directly into the throat 24. It will be appreciated that to allow the paper tray or drawer 22 to be readily removed for reloading, the feed roller or feed belt 14 is located above the paper stack 100 in a position not to interfere with removal of the tray. During the paper feed cycle, the belt or roller 14 temporarily moves into position to contact the upper surface 102 of the paper stack 100.

In an alternate bottom-feeding embodiment, seen in FIGS. 2, and 5-6, the tray or drawer 22 has a slot 26 in its bottom though which the counter-rotating feed rollers 14 of the type disclosed in U.S. Pat. No. 8,074,912 pass to contact the bottom sheet of the stack 100 so as to “suck” sheets from the bottom of the stack and feed them into the shredder input throat. A pair of belts moving in opposite directions can take the place of the rollers 14. The shredder is constructed so that when the feed rollers 14 are in an active contacting position, the tray or drawer 22 is locked closed. When the feed rollers 14 are inactive, they retract and the tray or drawer 22 unlocks so that it can be refilled. The locking of the tray or drawer 22 can be automatic or under manual control. In a manual system, when the tray or drawer 22 is inserted into the shredder 10, a catch 28 locks the tray or drawer 22 in position and a sensor 30 is activated to determine if the tray or drawer 22 contains paper. If the tray or drawer 22 does contain paper, the feed rollers 14 move up into contact with the lower surface of the paper stack 100. When the user desires to withdraw the drawer 22 to insert additional paper, the user presses a switch or a lever that unlocks the catch 28, and simultaneously causes the feed rollers 14 to retract which then allows the tray or drawer 22 to be withdrawn.

It will be appreciated that for such a bottom feed roller configuration to operate reliably, the tray or drawer 22 must be equipped with means to uniformly press the stack down onto the feed rollers 14. This can be accomplished either by a spring-loaded, hinged bias plate under which the sheets of paper 100 are placed when one loads the tray or drawer 22 or by a mechanically driven pressure plate 32 that descends into the tray or drawer 22 when the tray or drawer 22 is inserted into the shredder. The same sensor 30 that controls movement of the feed rollers 14 could also control the mechanically driven pressure plate 32 so that like the feed rollers 14 (or moving belts), the pressure plate 32 automatically retracts when the tray or drawer 22 is slid out for loading purposes. The input slot 12 is configured so that inserted sheets of paper are deflected to the feed rollers 14 when the tray or drawer 22 is empty.

To review operation of an automatic bottom-feeding embodiment of the drawer loading under desk paper shredder 10: to shred a stack of documents 100, the tray or input drawer 22 is slid out from the unit 10. In a preferred embodiment, the entire tray or drawer 22 can be removed from the shredder 10 so that loading documents can be conveniently accomplished on the user's work desk. The tray or drawer 22 is not unlike an input drawer for a copier, fax machine or printer. The tray or drawer 22 is equipped with guides so the tray can be adjusted to accept paper stacks 100 of several standard dimensions (e.g., letter, legal and A4). The tray or drawer 22 has an opening slot 26 in its lower surface for the feed rollers 14 to at least partially pass. The tray or drawer 22 is loaded with a stack of documents 100 and slid back into the shredder 10. Assuming that the shredder 10 is set to “automatic” or “on”, a sensor 30 determines whether or not there are documents in the drawer 22. If there are, the tray or drawer 22 is locked and the feed rollers 14 ascend to make contact with the lower sheet of the paper stack 100. At the same time, any upper surface pressure device 32 present activates to press the paper stack 100 into contact with the rollers 14. The rollers 14 then activate and sheets of paper are pulled from the bottom of the stack 100 and fed into the input throat of a shredding mechanism 16. A sensor 36 in the shredder input throat (not shown for clarity) detects the paper and starts the shredding mechanism 16. Shredding continues until the stack 100 is exhausted. When there is no more paper being fed into the shredder input throat, the shredding mechanism 16 stops. The stack sensor 30 determines that the drawer 22 is empty so the feed rollers 14 deactivate and move downward and into a “safe” position (at the same time, any upper surface pressure device 32 also withdraws) so that the drawer 22 can be opened for addition of more paper.

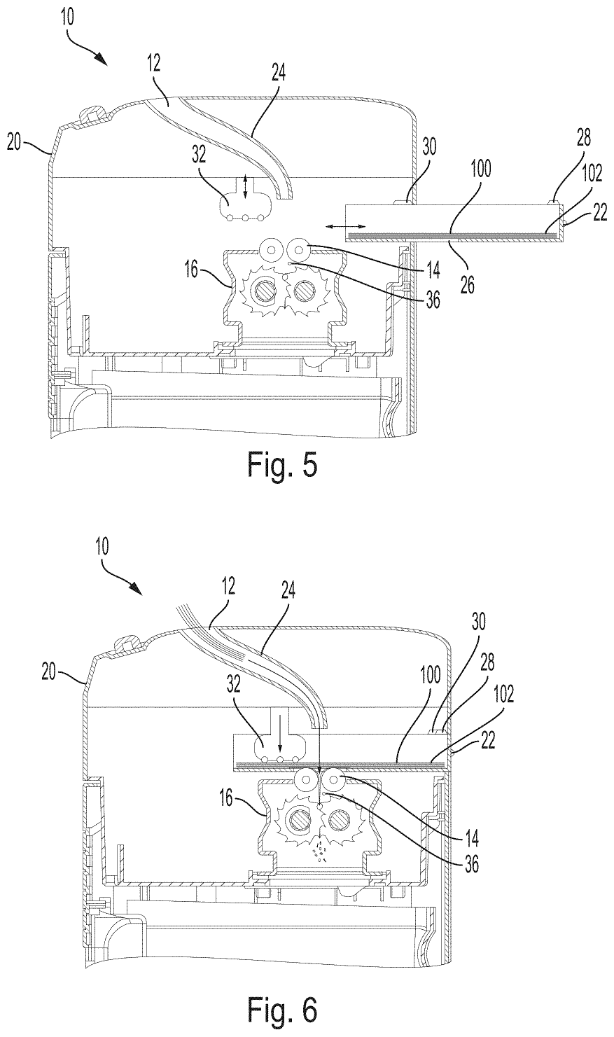

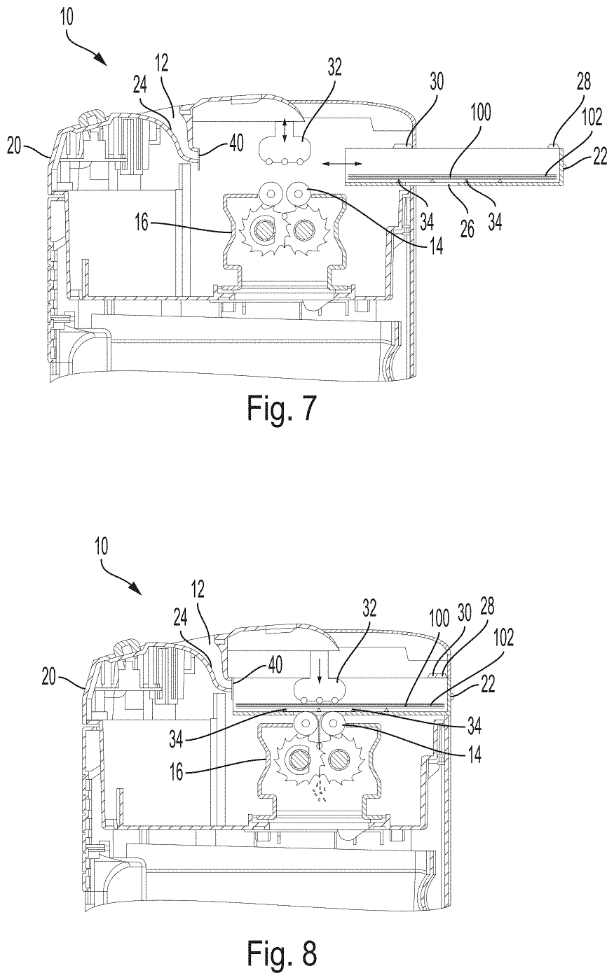

FIGS. 7-8 illustrate another bottom-feeding embodiment of a shredder 10 that shreds paper from the pull-out tray or drawer 22, or from the manual paper feed slot 12, or simultaneously from both the manual paper feed slot 12 and the tray or drawer 22. This embodiment is similar to the embodiment seen in FIGS. 5-6, except paper inserted through the manual input slot 12 moves down a throat 24 into the pull-out tray or drawer 22 when the pull-out tray or drawer 22 is in a closed position. When the paper shredder 10 is not in operation and the paper tray or drawer 22 is empty and in a closed position, documents fed into the manual feed slot 12 will be guided along the throat 24 into the paper tray or drawer 22. Once the paper(s) is in the pull-out tray or drawer 22, paper sensors 34 (e.g., a mechanical sensor, a photo sensor, etc.) located close to the feed rollers 14 detect the presence of at least one sheet of paper in the tray or drawer 22 and activate a pressure plate 32 which will move from an upper position to a lower position to apply pressure to the top of the paper(s) and the feed rollers 14 below will move upwards into contact with the bottommost sheet of paper, and start feeding the paper(s) into the blades of the shredding mechanism 16. In the alternative, the sensor 30 can detect the presence of paper in the tray or drawer 22. Movement of the pressure plate 32 from an upper position to a lower position is triggered when the pull-out tray or drawer 22 is closed as the safety trigger sensor 30 will trigger the pressure plate 32 to move downward to press against the top of the stack of papers 100 when the sensor 30 detects the tray or drawer 22 is closed, and paper is present in the tray or drawer 22 (or if the paper sensors 34 detect paper in the tray or drawer 22). When no paper is detected in the pull-out tray or drawer 22, the sensor 30 (alone or in combination with the paper sensors 34) will trigger the pressure plates 32 to move into the raised or upper position. A flap mechanism 40 may be positioned at the end of the throat 24. When the tray or drawer 22 is closed, and no paper is detected in the pull-out tray or drawer 22, the flap of the flap mechanism 40 will move from a closed position blocking an opening of the throat 24 to an open position, and allowing paper to move from the throat 24 into the tray or drawer 22. When the tray or drawer 22 is opened, the flap of the flap mechanism 40 will move from the open position to the closed position, and block paper from entering the interior of the unit 10. Paper(s) can also be put into the pull-out tray or drawer 22 directly where shredding will begin as soon as the tray or drawer 22 is moved to the closed position, and activates the safety trigger sensor 30. If paper is being shredded from the paper tray or drawer 22 in autofeed mode, the flap of the flap mechanism 40 inside the throat 24 will be in the closed position. If the paper tray or drawer 22 is moved towards the open position, the safety trigger tab or catch 28 will disengage from the safety trigger sensor 30 with all shredding operation ceasing immediately and the pressure plate 32 will lift upwards away from the stack of papers 100 to the upper position.

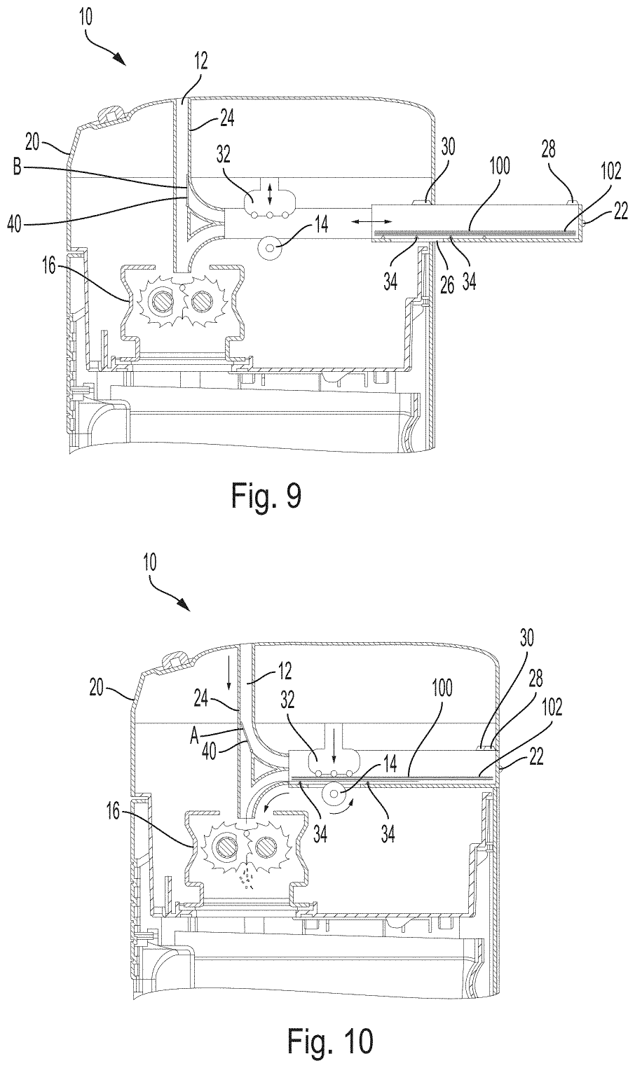

FIGS. 9-10 illustrate an additional bottom-feeding embodiment of a shredder 10 that shreds paper from the pull-out tray or drawer 22, or from the manual paper feed slot 12, or simultaneously from both the manual paper feed slot 12 and the tray or drawer 22. When the paper shredder 10 is not in operation and the paper tray or drawer 22 is empty, documents fed into the manual feed slot 12 will be guided along a throat 24 into the paper tray or drawer 22 via a flap mechanism 40 which will be in a first position “A” (see FIG. 10). Once the paper(s) is in the pull-out tray or drawer 22, paper sensors 34 (e.g., a mechanical sensor, a photo sensor, etc.) located close to the feed rollers 14 detect the presence of at least one sheet of paper in the tray or drawer 22 and activate a pressure plate 32 which will move from an upper position to a lower position to apply pressure to the top of the paper(s) and at least one feed roller or belt 14 below will move upwards into contact with the bottommost sheet of paper, and start feeding the paper(s) into a throat shaped to bring the paper(s) to the input throat of the shredding mechanism 16 and into the blades of the shredding mechanism 16. Paper(s) can also be put into the pull-out tray or drawer 22 directly where shredding will begin as soon as the tray or drawer 22 is moved to the closed position, and activates the safety trigger sensor 30. If paper is being shredded from the paper tray or drawer 22 in autofeed mode, the flap of the flap mechanism 40 inside the throat 24 will automatically switch to a second position “B” (see FIG. 9), and guide the paper straight into the blades of the shredding mechanism 16. Additional paper can be shredded simultaneously by feeding the paper through the manual feed slot 12 into the throat 24. If the paper tray or drawer 22 is moved towards the open position, the safety trigger tab or catch 28 will disengage from the safety trigger sensor 30 with all shredding operation ceasing immediately and the pressure plate 32 will lift upwards away from the stack of papers 100 to the upper position.

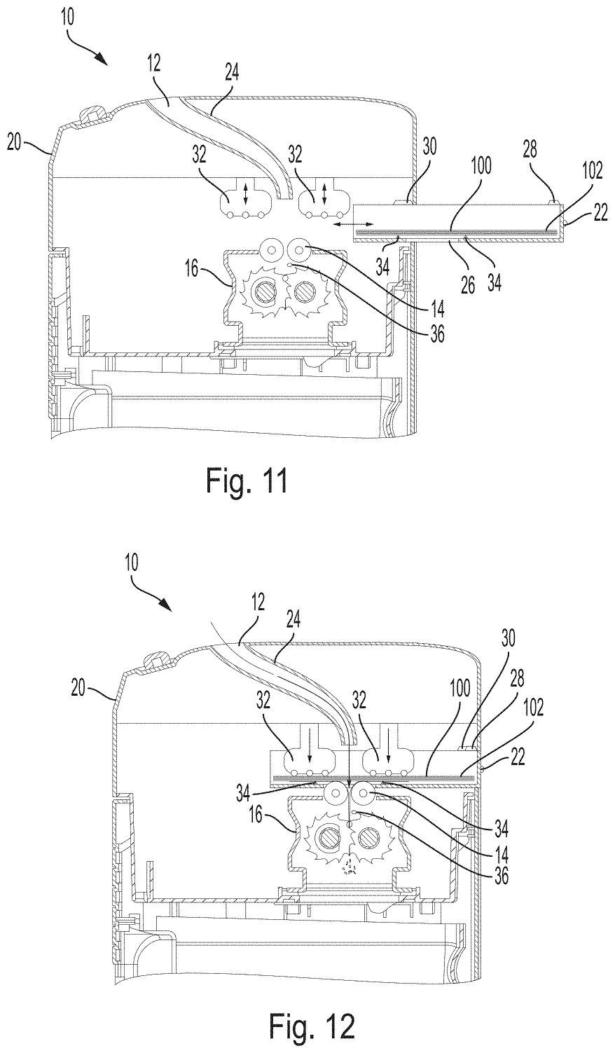

FIGS. 11-12 illustrate another bottom-feeding embodiment of a shredder 10 that shreds paper from the pull-out tray or drawer 22, or from the manual paper feed slot 12. This embodiment is similar to the embodiment seen in FIGS. 5-6, but this embodiment includes two pressure plates 32. As seen in FIGS. 11-12, the auto-feeding paper shredder 10 includes a pull-out paper tray or drawer 22 where a stack of paper documents 100 can be put directly into the pull-out tray or drawer 22 or put through a manual feed slot 12. Similar to the other embodiments discussed above, when papers are put into the pull-out tray or drawer 22 and the pullout-tray or drawer 22 is closed, the two pressure plates 32 will move from an upper position to a lower position. Movement of the two pressure plates 32 from the upper position to the lower position is triggered when the pull-out tray or drawer 22 is closed as the safety trigger sensor 30 will trigger the pressure plates 32 to move downward to press against the top of the stack of papers 100 when the sensor 30 detects the tray or drawer 22 is closed. Alternatively, the sensor 30 can also trigger the pressure plates 32 to move downward from the upper position to the lower position if the sensor 30 detects paper in the pull-out tray or drawer 22 (likewise, when no paper is detected in the pull-out tray or drawer 22, the sensor 30 will trigger the pressure plates 32 to move into the raised or upper position). Again, the pull-out tray or drawer 22 has an open slot 26 at the bottom though which counter-rotating feed rollers 14 can grab a bottom sheet of the stack of papers 100 placed in the tray or drawer 22 and pull the bottom sheet into the blades of the shredding mechanism 16. There are paper sensors 34 (e.g., a mechanical sensor, a photo sensor, etc.) located close to the feed roller 14 to detect if there is paper in the tray or drawer 22. If so, the paper sensors 34 will activate the feed rollers 14 to start feeding paper at the bottom of the stack 100 into the shredding mechanism 16 until there are no more papers left in the tray or drawer 22. If the paper sensors 34 detect no paper in the tray or drawer 22 (e.g., the tray or drawer is empty), paper can be shredded through the manual feed slot 12. Papers fed into the manual feed slot 12 are guided into the gap between the feed rollers 14 where a paper sensor 36 will activate the shredding mechanism 16. If the tray or drawer 22 is pulled towards the open position, opened, the safety trigger tab or catch 28 will disengage from the safety trigger sensor 30 and all shredding operation will cease immediately (i.e., the shredding mechanism 16 will deactivate) and the pressure plates 32 will lift away from the stack of papers 100. If paper is slid into the manual feed slot 12 while paper is still in the tray or drawer 22, the leading edge of the paper slid into the manual feed slot 12 will contact the top sheet of paper of the stack of papers 100 and prevented from any further movement towards the shredding mechanism 16 by the top sheet of paper until the rollers 14 grab that top sheet of paper (by then, generally the last sheet of paper left from the stack 100) and pull that sheet towards the shredding mechanism 16. At that point, the paper that had been slid into the manual feed slot 12 will move downward between the rollers 14 and towards the blades of the shredding mechanism 16.

The unit 10 may include a control assembly (not shown) located on the front, top, or on any of the other sides of the unit 10, or anywhere desired on the unit 10 for ergonomics and convenience of the user. The control assembly includes various electronics (e.g., a processor, a memory, etc.) configured to allow a user to operate the paper shredder assembly 10 by providing buttons/switches for operation of the assembly 10 and indicators to inform a user about various conditions of the assembly 10. For example, there is an indicator (e.g., a red LED) for indicating a “closed” or “locked” condition of the drawer 22, and another indicator (e.g., a green LED) for indicating an “open” or “unlocked” condition of the drawer 22. Likewise, the control assembly may include an on/start or “power” button/switch to power on the assembly 10, an off/stop button/switch to turn off the assembly 10, a forward button/switch to set the direction of the blades of the shredding mechanism 16 and/or rollers/belts 14 in a forward direction, a reverse button/switch to set the direction of the blades of the shredding mechanism 16 and/or rollers/belts 14 in a reverse direction (e.g., in case of a paper jam). Other indicators may be on the panel of the control assembly including a door open indicator (e.g., a red LED) 56 (e.g., to indicate that the front access door 80 of the housing is open, etc.), an overload indicator (e.g., a red LED to indicate that too much paper 100 has been placed within the drawer 22, too much shredded paper is contained within the waste bin 90, etc.), a power indicator (e.g., green LED to indicate that the assembly 10 is powered up), a bin full indicator (e.g., a red LED to indicate that the waste bin 90 is full, etc.) and, an overheat indicator (e.g., a red LED to indicate that the shredding mechanism 16 or motor is overheating). The sensors 34, 36 are connected to the electronics of the control assembly for operation of the unit 10.

In addition, the claimed invention is not limited in size and may be constructed in various sizes in which the same or similar principles of operation as described above would apply. Furthermore, the figures (and various components shown therein) of the specification are not to be construed as drawn to scale.

The terminology used herein is for the purpose of describing particular example embodiments only and is not intended to be limiting. As used herein, the singular forms “a”, “an” and “the” may be intended to include the plural forms as well, unless the context clearly indicates otherwise. In other words, an element or step recited in the singular and preceded by the word “a” or “an” should be understood as not necessarily excluding the plural of the elements or steps. Further, references to “one embodiment” or “one implementation” are not intended to be interpreted as excluding the existence of additional embodiments or implementations that also incorporate the recited features.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps. In other words, unless explicitly stated to the contrary, embodiments “comprising” or “having” an element or a plurality of elements having a particular property can include additional elements not having that property. In other words, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. In other words, the use of “including,” “comprising,” “having,” “containing,” “involving,” and variations thereof, is meant to encompass the items listed thereafter and additional items. Further, references to “one embodiment” or “one implementation” are not intended to be interpreted as excluding the existence of additional embodiments or implementations that also incorporate the recited features. The term “exemplary” is intended to mean “an example of”.

When introducing elements of aspects of the disclosure or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” The use of the expression “at least” or “at least one” suggests the use of one or more elements or ingredients or quantities, as the use may be in the embodiment of the disclosure to achieve one or more of the desired objects or results.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary. Any range or value given herein can be extended or altered without losing the effect sought, as will be apparent to the skilled person.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

While various spatial and directional terms, such as “top,” “bottom,” “upper,” “lower,” “vertical,” and the like are used to describe embodiments and implementations of the present disclosure, it is understood that such terms are merely used with respect to the orientations shown in the drawings. The orientations can be inverted, rotated, or otherwise changed, such that a top side becomes a bottom side if the structure is flipped 180 degrees, becomes a left side or a right side if the structure is pivoted 90°, and the like. In other words, spatially relative terms, such as “front,” “rear,” “left,” “right,” “inner,” “outer,” “beneath”, “below”, “lower”, “above”, “upper”, “horizontal”, “vertical”, “lateral”, “longitudinal” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

In the description of the present invention, it should be understood that the orientation or position relationship indicated by the terms “up”, “down”, “front”, “rear”, “left”, “right”, “vertical”, “horizontal”, “top”, “bottom”, “inside”, “outside”, and the like is based on the orientation or position relationship shown in the accompanying drawings, it is only for the convenience of description of the present invention and simplification of the description, and it is not to indicate or imply that the indicated device or element must have a specific orientation, and be constructed and operated in a specific orientation. Therefore, the terms shall not be understood as limiting the present invention.

In the description of the present invention, several means one or more, a plurality of means more than two, greater than, less than, more than, and the like are understood as not including this number, while above, below, within, and the like are understood as including this number. If there are the descriptions of first and second, it is only for the purpose of distinguishing technical features, and should not be understood as indicating or implying relative importance, implicitly indicating the number of the indicated technical features or implicitly indicating the order of the indicated technical features.

In the description of the present invention, it should be noted that the terms “installation”, “connected” and “connection” if any shall be understood in a broad sense unless otherwise specified and defined. For example, they may be fixed connection, removable connection or integrated connection; may be mechanical connection or electrical connection; and may be direct connection, or indirect connection through an intermediate medium, and connection inside two elements. The specific meanings of the above terms in the present invention can be understood in a specific case by those of ordinary skills in the art.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above can relate to one embodiment or can relate to several embodiments. The embodiments are not limited to those that solve any or all of the stated problems or those that have any or all of the stated benefits and advantages. It will further be understood that reference to ‘an’ item refers to one or more of those items.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation (e.g., different steps, etc.) is within the scope of aspects and implementations of the disclosure. In other words, the method steps, processes, and operations described herein are not to be construed as necessarily requiring their performance in the particular order discussed or illustrated, unless specifically identified as an order of performance. It is also to be understood that additional or alternative steps may be employed.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of.” “Consisting essentially of,” when used in the claims, shall have its ordinary meaning as used in the field of patent law.

As briefly discussed above, as used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are example embodiments. Many other embodiments will be apparent to those of ordinary skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person of ordinary skill in the art to practice the various embodiments of the disclosure, including making and using any devices or systems and performing any incorporated methods. The patentable scope of the various embodiments of the disclosure is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

The above description presents the best mode contemplated for carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above that are fully equivalent. Moreover, features described in connection with one embodiment of the invention may be used in conjunction with other embodiments, even if not explicitly stated above. Consequently, this invention is not limited to the particular embodiments disclosed. On the contrary, this invention covers all modifications and alternate constructions coming within the spirit and scope of the invention as generally expressed by the following claims, which particularly point out and distinctly claim the subject matter of the invention.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

Various technical features of the above embodiments may be combined randomly, and in order to simplify the description, possible combinations of various technical features in the above embodiments are not all described. However, as long as the combinations of these technical features have no contradiction, the combinations of these technical features should be considered as falling into the scope recorded by the specification.

Although the embodiments of the present invention have been shown and described, those of ordinary skills in the art may understand that various changes, modifications, substitutions and variations may be made to these embodiments without departing from the principle and purpose of the present invention, and the scope of the present invention is defined by the claims and their equivalents.

What is claimed is:

1. An auto-feed paper shredder configured to fit under a desktop comprising:
a housing containing a paper shredding mechanism;
an input slot on a surface of the housing disposed so that sheets of paper can be manually inserted when the auto-feed paper shredder is placed beneath a desktop;
a horizontally oriented, slidable drawer insertable into a front surface of the paper shredder for holding a stack of paper to be shredded; and
an auto-feed apparatus configured to remove sheets of paper from the stack and convey the sheets to the paper shredding mechanism when the slidable drawer is inserted into the paper shredder.

2. The auto-feed paper shredder according to claim 1, wherein the auto-feed apparatus comprises a pair of counter-rotating rollers or belts for removing sheets of paper from a lower surface of the stack; and wherein the drawer includes a bottom slot through which the sheets pass to the paper shredding mechanism.

3. The auto-feed paper shredder according to claim 2, wherein the auto-feed apparatus has an upper position wherein the pair of counter-rotating rollers or belts contacts the lower surface of the stack and a lower position wherein the pair of counter-rotating rollers or belts do not contact the lower surface of the stack to allow the drawer to be inserted into or removed from the paper shredder.

4. The auto-feed paper shredder according to claim 2 further comprising a sensor system for determining whether the slidable drawer contains paper when the slidable drawer is slid into the auto-feed paper shredder.

5. The auto-feed paper shredder according to claim 4, wherein the auto-feed apparatus is configured to move into the upper position when the slidable drawer contains paper.

6. The auto-feed paper shredder according to claim 2, further comprising a pressure device for applying downward pressure to the stack of paper.

7. The auto-feed paper shredder according to claim 2, further comprising a flap moveable between first and second positions, wherein paper inserted into the an input slot moves into the drawer when the flap is in the first position.

8. The auto-feed paper shredder according to claim 2, wherein the drawer includes a bottom slot through which the sheets pass to the paper shredding mechanism.

9. The auto-feed paper shredder according to claim 1, wherein the sheets of paper inserted into the input slot move through a throat prior to being shredded.

10. The auto-feed paper shredder according to claim 9, further comprising a flap moveable between first and second positions, wherein paper inserted into the an input slot moves into the drawer for subsequent shredding when the flap is in the first position and directly into the shredding mechanism when the flap is in the second position.

11. An auto-feed paper shredder configured to fit under a desktop comprising:
a housing containing a paper shredding mechanism;
an input slot on a surface of the housing disposed so that sheets of paper can be manually inserted into the paper shredding mechanism when the auto-feed paper shredder is placed beneath a desktop;
a horizontally oriented, slidable drawer on a front surface for holding a stack of paper to be shredded; and an auto-feed apparatus comprising at least one roller or belt for removing sheets of paper from a lower surface of the stack and conveying the sheets to the paper shredding mechanism; wherein the drawer includes a bottom slot through which the at least one roller or belt extends to engage the lower surface of the stack.

12. The auto-feed paper shredder according to claim 11, wherein the auto-feed apparatus has an upper position wherein the pair of counter-rotating rollers or belts contacts the lower surface of the stack and a lower position wherein the pair of counter-rotating rollers or belts do not contact the lower surface of the stack to allow the drawer to be inserted into or removed from the paper shredder.

13. The auto-feed paper shredder according to claim 11 further comprising a sensor system for determining whether the slidable drawer contains paper when the slidable drawer is slid into the auto-feed paper shredder.

14. The auto-feed paper shredder according to claim 13, wherein the auto-feed apparatus is configured to move into the upper position when the slidable drawer contains paper.

15. The auto-feed paper shredder according to claim 11 further comprising a pressure device for applying downward pressure to the stack of paper.

16. The auto-feed paper shredder according to claim 1, wherein the sheets of paper inserted into the input slot move through a throat prior to being shredded.

17. The auto-feed paper shredder according to claim 16, further comprising a flap moveable between first and second positions, wherein paper inserted into the an input slot moves into the drawer for subsequent shredding when the flap is in the first position and directly into the shredding mechanism when the flap is in the second position.

18. The auto-feed paper shredder according to claim 11, wherein the at least one roller or belt comprises a pair of counter-rotating rollers or belts for removing sheets of paper from the lower surface of the stack; and wherein the sheets pass through the bottom slot to the paper shredding mechanism.
